(19) United States
(12) Patent Application Publication
(10) Pub. No.: US 2008/0057361 A1
(43) Pub. Date: Mar. 6, 2008

(54) FUEL CELL POWER GENERATION SYSTEM USING FUEL ELECTRODE EXHAUST GAS RECYCLING PROCESS

(75) Inventors: Kil Ho Moon, Busan (KR); Tae Won Lee, Daejeon (KR); Gi Pung Lee, Daejeon (KR); Yun Sung Kim, Daejun (KR); Jeong Seok Yoo, Daejeon (KR)

Correspondence Address: DUANE MORRIS, LLP;IP DEPARTMENT, 30 SOUTH 17TH STREET, PHILADELPHIA, PA, 19103-4196, US

(73) Assignee: DOOSAN HEAVY INDUSTRIES & CONSTRUCTION CO., LTD, Seoul (KR)

(21) Appl. No.: 11/680,983

(22) Filed: Mar. 1, 2007

(30) Foreign Application Priority Data
Sep. 1, 2006 (KR) 10-2006-0084043

(51) Int. Cl. H01M 8/18

(52) U.S. Cl. 429/19

(57) ABSTRACT

Disclosed herein is an internal reforming molten carbonate fuel cell power generation system including a reformer mounted in a stack for converting a hydrocarbon-based substance, such as natural gas, into hydrogen. The fuel cell power generation system includes a stack for generating power by a fuel cell reaction, a mixer for mixing fuel to be supplied to the stack, a pre-former disposed between the mixer and the stack for reforming a portion of fuel to be supplied to the stack from the mixer, and a burner for burning exhaust gas exhausted from a fuel electrode of the stack to supply heat and carbon dioxide required for the air electrode of the stack. An exhaust gas recycling line diverges from an exhaust gas line between the stack and the burner. The exhaust gas recycling line is connected to a fuel supply line between the mixer and the stack, whereby a portion of exhaust gas, exhausted from the fuel electrode of the stack after the reaction is completed, is mixed with the fuel flowing along the fuel supply line between the mixer and the stack, and then the mixture is reintroduced into the fuel electrode of the stack.

### BACKGROUND OF THE INVENTION

1. Field of the Invention

The present invention relates to an internal reforming molten carbonate fuel cell power generation system including a reformer mounted in a stack for converting a hydrocarbon-based substance, such as natural gas, into hydrogen, and, more particularly, to a fuel cell power generation system using a fuel electrode exhaust gas recycling process that is capable of reusing a portion of unreacted gas and steam exhausted from a fuel electrode of the stack as fuel for the fuel electrode, thereby reducing the amount of used fuel and steam and the size of facilities for supplying the natural gas and the steam, and therefore, improving the power generation efficiency of the fuel cell power generation system and the economic efficiency of the fuel cell power generation system.

2. Description of the Related Art

Based on kinds of used electrolytes, fuel cells are classified into a polymer electrolyte fuel cell and an alkaline fuel cell which are operated at a temperature higher than room temperature and lower than 100° C., a phosphoric acid fuel cell which is operated at a temperature of 150 to 200° C., a molten carbonate fuel cell which is operated at a high temperature of 600 to 700° C., and a solid oxide fuel cell which is operated at a high temperature exceeding 1000° C. These fuel cells are operated according to the same operational principle; however, the fuel cells use different kinds of fuels, have different operating temperatures, have different kinds of catalysts, and have different kinds of electrolytes.

Among them, the molten carbonate fuel cell is also classified as an internal reforming molten carbonate fuel cell, which generates hydrogen required for a reaction inside a stack, or an external reforming molten carbonate fuel cell, which generates hydrogen required for a reaction outside a stack.

In the internal reforming molten carbonate fuel cell, a hydrocarbon compound, such as natural gas, is used as fuel gas supplied to a fuel cell (anode). Generally, a hydrocarbon compound having two or more carbon atoms is primarily converted into hydrogen using a pre-former such that the concentration of hydrogen in the fuel gas is maintained at 2% or more, and then the hydrocarbon compound is supplied to the fuel electrode of the stack for accelerating the steam reforming reaction occurring in the stack.

A conventional power generation system using such an internal reforming molten carbonate fuel cell is illustrated in FIG. 1.

As shown in FIG. 1, the conventional power generation system using the internal reforming molten carbonate fuel cell is constructed in a structure in which natural gas NG and steam, which constitute fuel, are supplied into a mixer 3 from their respective sources such that the natural gas NG and the steam can be sufficiently mixed by the mixer, and then the mixed fuel is supplied into a pre-former 2. The steam is supplied by an amount equivalent to 2 to 5 times that of the supplied carbon. In the pre-former 2, a portion of the hydrocarbon compound is reformed with the result that the hydrogen concentration is maintained at 3 to 20%. Also, the fuel is generally supplied into a stack 1 with a flow rate equivalent to 120 to 150% of a theoretical reaction flow rate such that a required reaction can sufficiently occur.

After the fuel cell reaction in the stack 1, gas discharged from a fuel electrode includes the remainder of the excessively supplied hydrogen and carbon dioxide (CO₂) and steam generated after the reaction. This fuel electrode exhaust gas is supplied into a burner 4 where the hydrogen is burned to collect required heat. The carbon dioxide included in the exhaust gas is supplied to an air electrode (cathode) such that the carbon dioxide is used for the reaction. Air required at the air electrode is obtained from air introduced through an air introduction fan 5. As the air passes through the burner 4, the air is heated to a desired temperature. According to circumstances, a portion of the gas exhausted from the air electrode is resupplied to the air electrode of the stack 1 through an air electrode circulation fan 6 such that the air can be reused at the air electrode.

The exhaust gas, exhausted from the fuel electrode of the stack 1 after the above-described reaction is completed, contains a large amount of unreacted hydrogen. In the conventional power generation system, however, the exhaust gas is burned by the burner 4 only to supply heat and carbon dioxide required for the air electrode. For this reason, it is necessary to supply a large amount of natural gas and a large amount of steam. As a result, the fuel consumption is increased, and the size of facilities for supplying the natural gas and the steam is increased, whereby the total efficiency of the conventional power generation system is decreased.

### SUMMARY OF THE INVENTION

Therefore, the present invention has been made in view of the above problems.

It is an object of the present invention to provide a fuel cell power generation system using a fuel electrode exhaust gas recycling process that is capable of reusing a portion of unreacted gas and steam exhausted from a fuel electrode of the stack as fuel for the fuel electrode, thereby reducing the amount of used fuel and steam, reducing the size of facilities for supplying the natural gas and the steam, and therefore, improving the power generation efficiency of the fuel cell power generation system and the economic efficiency of the fuel cell power generation system.

In accordance with the present invention, the above and other objects can be accomplished by the provision of an internal reforming molten carbonate fuel cell power generation system using a fuel electrode exhaust gas recycling process, including a stack for generating power by a fuel cell reaction, a mixer for mixing fuel to be supplied to the stack, a pre-former disposed between the mixer and the stack for reforming a portion of fuel to be supplied to the stack from the mixer, and a burner for burning exhaust gas exhausted from a fuel electrode of the stack to supply heat and carbon dioxide required for the air electrode of the stack, wherein the fuel cell power generation system further includes an exhaust gas recycling line diverging from an exhaust gas line between the stack and the burner, the exhaust gas recycling line being connected to a fuel supply line between the mixer and the stack, whereby a portion of exhaust gas, exhausted from the fuel electrode of the stack after the reaction is completed, is mixed with the fuel flowing along the fuel supply line between the mixer and the stack, and then the mixture is reintroduced into the fuel electrode of the stack.

Preferably, the exhaust gas recycling line is connected to the fuel supply line before the pre-former.

Preferably, the fuel cell power generation system further includes an exhaust gas discharger mounted at the junction between the exhaust gas recycling line and the fuel supply line for discharging the exhaust gas flowing along the exhaust gas recycling line to the fuel supply line.

Preferably, the exhaust gas discharger is a venturi-type ejector constructed such that negative pressure is formed in the exhaust gas recycling line due to the flow speed of the fuel gas passing through the venturi-type ejector with the result that the exhaust gas is automatically suctioned into the fuel supply line.

Preferably, the exhaust gas discharger is a high-temperature circulation fan constructed such that the exhaust gas flowing along the exhaust gas recycling line is forcibly supplied to the fuel supply line by the high-temperature circulation fan.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a system diagram illustrating the construction of a conventional fuel cell power generation system; and

FIG. 2 is a system diagram illustrating the construction of a fuel cell power generation system using a fuel electrode exhaust gas recycling process according to the present invention.

### DESCRIPTION OF THE PREFERRED EMBODIMENTS

Now, a preferred embodiment of the present invention will be described in detail with reference to the accompanying drawings.

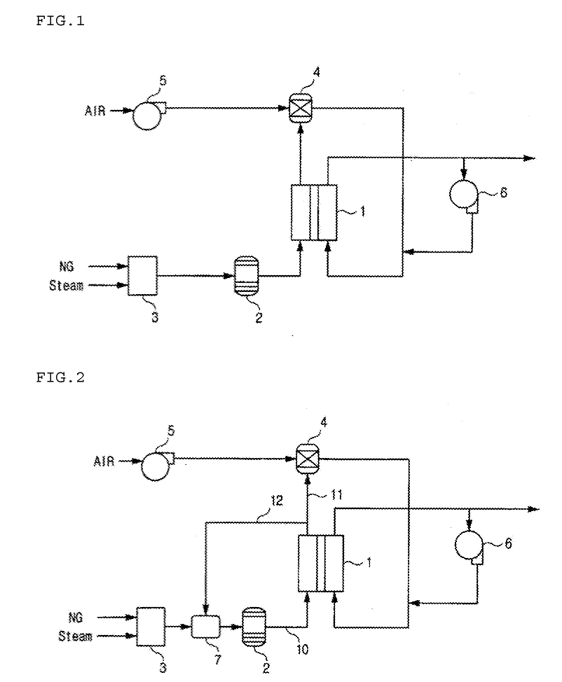

FIG. 2 is a system diagram illustrating the construction of a fuel cell power generation system using a fuel electrode exhaust gas recycling process according to the present invention. Elements of the fuel cell power generation system according to the present invention that are similar or identical to those of the conventional power generation system shown in FIG. 1 are denoted by the same reference numerals.

As shown in FIG. 2, the fuel cell power generation system using the fuel electrode exhaust gas recycling process according to the present invention is constructed in a structure in which a portion of exhaust gas, exhausted from a stack 1 of an internal reforming molten carbonate fuel cell power generation system after the fuel cell reaction is completed, is recycled to a fuel electrode such that unreacted hydrogen contained in the exhaust gas is reused for the fuel cell reaction.

The internal reforming molten carbonate fuel cell power generation system includes a stack 1 for generating power by the fuel cell reaction, a mixer 3 for mixing fuel to be supplied to the stack 1, a pre-former 2 disposed between the mixer 3 and the stack 1 for reforming a portion of fuel to be supplied to the stack 1 from the mixer 3, and a burner 4 for burning exhaust gas exhausted from a fuel electrode of the stack 1 to supply heat and carbon dioxide required for the air electrode of the stack 1.

Here, a line connecting the mixer 3, the pre-former 2, and the stack 1 is a fuel supply line 10, and a line connecting the stack 1 and the burner 4 is an exhaust gas line 11.

The fuel cell power generation system according to the present invention is constructed in a structure in which an exhaust gas recycling line 12 diverges from the exhaust gas line 11 between the stack 1 and the burner 4, and the exhaust gas recycling line 12 is connected to the fuel supply line 10 between the mixer 3 and the stack 1. Consequently, a portion of exhaust gas, exhausted from the fuel electrode of the stack 1 after the reaction is completed, is mixed with the fuel flowing along the fuel supply line 10 between the mixer 3 and the stack 1, and then the mixture is reintroduced into the fuel electrode of the stack 1.

Preferably, the exhaust gas recycling line 12 is connected to the fuel supply line 10 before the pre-former 2, as shown in FIG. 2, such that steam generated from the fuel cell reaction at the stack 1 is used for the reforming reaction at the pre-former 2 together with unreacted hydrogen contained in the exhaust gas.

At the junction between the exhaust gas recycling line 12 and the fuel supply line 10 is mounted an exhaust gas discharger 7 for discharging the exhaust gas flowing along the exhaust gas recycling line 12 to the fuel supply line 10.

As the exhaust gas discharger 7, there may be used a venturi-type ejector for generating pressure difference between the fuel supply line 10 and the exhaust gas recycling line 12. In this case, negative pressure is formed in the exhaust gas recycling line 12 due to the flow speed of the fuel gas passing through the venturi-type ejector with the result that the exhaust gas is automatically suctioned into the fuel supply line 10. Since the fuel in the fuel supply line 10 is normally maintained at a pressure of 3 bar, the venturi-type ejector utilizes the kinetic energy of the introduced fuel to obtain cycling power without using an additional power source.

As the exhaust gas discharger 7, on the other hand, there may be used a high-temperature circulation fan instead of the venturi-type ejector. In this case, the exhaust gas flowing along the exhaust gas recycling line 12 is forcibly supplied to the fuel supply line 10 by the high-temperature circulation fan.

In the internal reforming molten carbonate fuel cell power generation system using the fuel electrode exhaust gas recycling process with the above-described description according to the present invention, natural gas and steam are sufficiently mixed by the mixer 3, and then the mixed fuel is supplied to the pre-former 2. The steam is supplied by an amount equivalent to 2 to 5 times that of the supplied carbon. In the pre-former 2, a portion of the hydrocarbon compound is reformed such that hydrogen concentration is maintained at 3 to 20%. As the fuel passes through the stack 1, more than 99% of the fuel is converted into hydrogen, which is used in the fuel cell reaction. Since the fuel is excessively supplied, hydrogen is naturally contained in the fuel electrode exhaust gas. Also, steam and carbon dioxide generated by the fuel cell reaction are also contained in the fuel electrode exhaust gas. Less than 40% of the exhaust gas is recycled into the exhaust gas discharger 7 along the exhaust gas recycling line 12, and the introduced exhaust gas is mixed with newly introduced natural gas and steam in the exhaust gas discharger 7. After that, the mixture is introduced into the pre-former 2. When the amount of the recycled exhaust gas exceeds 40% of the total amount of the exhaust gas, peak voltage is greatly reduced, and load of the stack 1 is increased. Consequently, it is preferable that the amount of the recycled exhaust gas is maintained at less than 40% of the total amount of the exhaust gas.

Table 1 below shows the results of process simulation based on a fuel electrode cycling rate to measure the improvement of system efficiency obtained through the present invention.

TABLE 1

| | | | | |
|---|---|---|---|---|
| Cycling | 0% | 10% | 25% | 40% |
| rate | | | | |
| Fuel | 0% | 2.4% | 6.1% | 9.6% |
| saving | | | | |
| rate | | | | |
| Steam | 0% | 18.7% | 46.4% | 76.2% |
| saving | | | | |
| rate | | | | |
| Peak | 0.815 | 0.811 | 0.803 | 0.795 |
| voltage | | | | |
| (V) | | | | |

As can be seen from Table 1 above, when the hydrogen and the steam contained in the exhaust gas exhausted from the stack 1 are reused according to the present invention, (a) it is possible to reduce the amount of fuel consumed by the fuel cell power generation system through the reuse of the exhausted hydrogen, (b) it is possible to reduce the waste of the steam through the reuse of the steam generated from the stack and to reduce the size of the steam generator, (c) it is possible to reduce the amount of energy used to generate the steam, and (d) it is possible to increase the initial operation temperature of newly supplied fuel without the further introduction of energy by virtue of the temperature of the exhaust gas.

As can also be seen from Table 1 above, on the other hand, the peak voltage was slightly decreased due to the composition change of the fuel. However, the above-described improvement is tremendous as compared to the decrease of the peak voltage. Consequently, the decrease of the power generation rate is ignored, and it is possible to set the most economical cycling rate depending upon the properties of the fuel.

As apparent from the above description, the exhaust gas exhausted from the fuel electrode is used only to supply heat and carbon dioxide required for the air electrode in the conventional power generation system.

In the fuel cell power generation system using the fuel electrode exhaust gas recycling process according to the present invention, however, a portion of the exhaust gas exhausted from the fuel electrode is reintroduced into the fuel electrode of the stack, and therefore, the amount of used fuel is reduced by the amount of the recycled hydrogen. Furthermore, the high-temperature steam generated through the fuel cell reaction is utilized in the pre-former, and therefore, the amount of used steam is reduced. Consequently, the power generation efficiency of the fuel cell power generation system is improved, and the economic efficiency of the fuel cell power generation system is also improved.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An internal reforming molten carbonate fuel cell power generation system using a fuel electrode exhaust gas recycling process, comprising:
a stack for generating power by a fuel cell reaction;
a mixer for mixing fuel to be supplied to the stack;
a pre-former disposed between the mixer and the stack for reforming a portion of fuel to be supplied to the stack from the mixer; and
a burner for burning exhaust gas exhausted from a fuel electrode of the stack to supply heat and carbon dioxide required for the air electrode of the stack, wherein the fuel cell power generation system further comprises:
an exhaust gas recycling line diverging from an exhaust gas line between the stack and the burner, the exhaust gas recycling line being connected to a fuel supply line between the mixer and the stack, whereby a portion of exhaust gas, exhausted from the fuel electrode of the stack after the reaction is completed, is mixed with the fuel flowing along the fuel supply line between the mixer and the stack, and then the mixture is reintroduced into the fuel electrode of the stack.

2. The fuel cell power generation system according to claim 1, wherein the exhaust gas recycling line is connected to the fuel supply line before the pre-former.

3. The fuel cell power generation system according to claim 2, further comprising:
an exhaust gas discharger mounted at the junction between the exhaust gas recycling line and the fuel supply line for discharging the exhaust gas flowing along the exhaust gas recycling line to the fuel supply line.

4. The fuel cell power generation system according to claim 3, wherein the exhaust gas discharger is a venturi-type ejector constructed such that negative pressure is formed in the exhaust gas recycling line due to the flow speed of the fuel gas passing through the venturi-type ejector with the result that the exhaust gas is automatically suctioned into the fuel supply line.

5. The fuel cell power generation system according to claim 3, wherein the exhaust gas discharger is a high-temperature circulation fan constructed such that the exhaust gas flowing along the exhaust gas recycling line is forcibly supplied to the fuel supply line by the high-temperature circulation fan.
